(19) United States
(12) Patent Application Publication
(10) Pub. No.: US 2026/0200048 A1
(43) Pub. Date: Jul. 16, 2026

(54) TOOL FOR INSERTING CONDUIT PULLING EYES

(71) Applicant: Jarrett Linneman, Burlington, WI (US)

(72) Inventor: Jarrett Linneman, Burlington, WI (US)

(21) Appl. No.: 19/451,015

(22) Filed: Jan. 16, 2026

Related U.S. Application Data
(60) Provisional application No. 63/745,959, filed on Jan. 16, 2025.

(51) Int. Cl. B25B 13/50

(52) U.S. Cl. CPC B25B 13/5091

(57) ABSTRACT

A tool for connecting to a power tool to install and tighten a pulling eye within a tube. The tool includes a receiving channel configured to accept an eye flange of the pulling eye. The tool includes a base at a bottom end of the receiving channel and a tool connector on an opposing side from the receiving channel. Two side extensions extend from the base and form opposing sides of the receiving channel. The base and the two side extension form a generally U-shaped socket as the receiving channel. For use, the tool is connected to the power tool, and placed over the eye flange of the pulling eye, whereby the eye flange is seated within the receiving channel. As the tool is rotated by the power tool, the tool rotates the pulling eye to thread it into or otherwise tighten it into the tube.

### CROSS REFERENCE TO RELATED APPLICATION

This application is claims the benefit of U.S. Provisional Patent Application, Ser. No. 63/745,959, filed on 16 Jan. 2025. The co-pending provisional patent application is hereby incorporated by reference herein in its entirety and is made a part hereof, including but not limited to those portions which specifically appear hereinafter.

### BACKGROUND OF THE INVENTION

This invention relates generally to rotary tools and tool attachments and, more particularly, to a tool for inserting and/or connecting pulling eyes (also known as a pulling internal or simply an integral) into conduit, such as for underground installation.

Conduit pulling eyes are inserted into conduit, piping, tubing, or equivalent (collectively “tubing”) as an attachment point for a pulling force to run the tubing through an installation (e.g., underground and/or inner-duct). Pulling eyes are generally inserted into open ends of tubing and manually tightened into place using a wrench, screwdriver, or other rod-type element. The jobsite installation is burdensome and can be a safety hazard. There is a need to an improved device and method for installation.

### SUMMARY OF THE INVENTION

A general object of the invention is to provide a tool that allows for use of power tools to insert a pulling eye. The general object of the invention can be attained, at least in part, through a tool for using a power tool to install and tighten a pulling eye within a tube, the tool including a receiving channel configured to accept an eye flange of the pulling eye.

In embodiments, the tool includes a base at a bottom end of the receiving channel. The base includes a tool connector for a power tool on an opposing side from the receiving channel. Two side extensions desirably extend from the base and form opposing sides of the receiving channel. The base and the two side extension are configured relative to the intended eye flange, but generally form a U-shaped socket with the receiving channel. The receiving channel generally has a length (and depth) that is greater than a width between the two side extensions.

In embodiments of this invention, the tool includes a base including a tool connector, the base including two opposing sides and two opposing ends and two side extensions, each extending along and outward from one of the two opposing sides of the base. The receiving channel is formed between the two side extensions to accept the eye flange of the pulling eye.

In embodiments, the receiving channel has a length (side-to-side) between about 2 inches and about 3 inches, a width of about 1 to about 2 inches between the two side extensions, and/or a height or depth of about 2 inches to about 4 inches. The tool is robust, and generally formed of a metal such as steel. The side extensions desirably have a thickness of at least about 0.25 inch, and desirably between about 0.25 inch and about 0.5 inch. The use of “about” generally designates about a ±10% range.

The tool of embodiments of this invention includes two side supports, each extending between corresponding sides of the two side extensions. In embodiments, an inside surface of each of the two side supports is at least partially curved (e.g., at corners) to coordinate with rounded edges of the pulling eye. In embodiments, the receiving channel has a length of about 2 to about 3 inches between the two side supports, desirably corresponding to a width of the eye flange to be received.

The base of the tool includes a suitable tool connector. The tool connector can vary depending on need. In embodiments, the tool connector is a drive socket to receive a drive extension (e.g., drive square) of a socket or power tool, such as a power drill, impact drill, or impact driver. The tool connector can include a detent to receive a ball, which is common on drive extensions.

The invention further includes a method of installing or tightening a pulling eye. The method includes connecting the tool described herein to a power tool, placing the tool over the eye flange of the pulling eye, whereby the eye flange is seated within the receiving channel, and rotating the tool with the power tool to rotate the pulling eye. The eye flange is securely seated between the side extensions to turn the eye flange and tighten threaded components of the pulling eye. In preferred embodiments, the pulling eye is threaded opposite the eye flange and is tightened onto or within a tube, conduit, cable, etc.

Other objects and advantages will be apparent to those skilled in the art from the following detailed description taken in conjunction with the appended claims and drawings.

### BRIEF DESCRIPTION OF THE DRAWINGS

FIG. 1 is a top side perspective view of a tool according to embodiments of this invention.

FIG. 2 is a bottom side perspective view of the tool according to FIG. 1.

FIG. 3 is a bottom end perspective view of the tool according to FIG. 1.

FIG. 4 is a top view of the tool according to FIG. 1.

FIG. 5 is a side view of the tool according to FIG. 1.

FIG. 6 is a sectional view of the tool according to FIG. 1.

FIGS. 7 and 8 show a tool according to embodiments of this invention.

FIGS. 9-11 show an operation of the tool according to embodiments of this invention.

### DESCRIPTION OF THE INVENTION

The invention includes a tool for rotary installation and/or tightening of a pulling eye within tubing. The pulling eye is inserted into the tubing and the tool interacts with an exposed eye flange end of the pulling eye to tighten the pulling eye within the tubing.

In embodiments, the tool of this invention is a tool attachment for existing rotary tools, such as electric or pneumatic impact wrenches, impact drivers, socket wrenches, and/or drills. The tool attachment can include any suitable attachment mechanism for the corresponding rotary tool, such as a drive socket for a square head drive of an impact wrench.

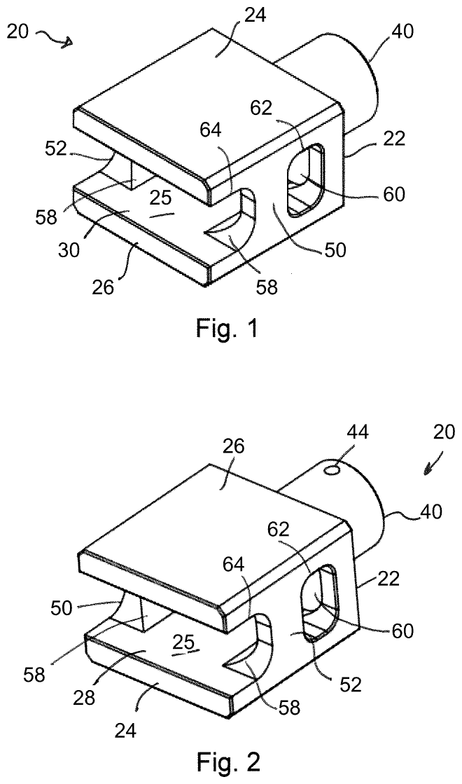

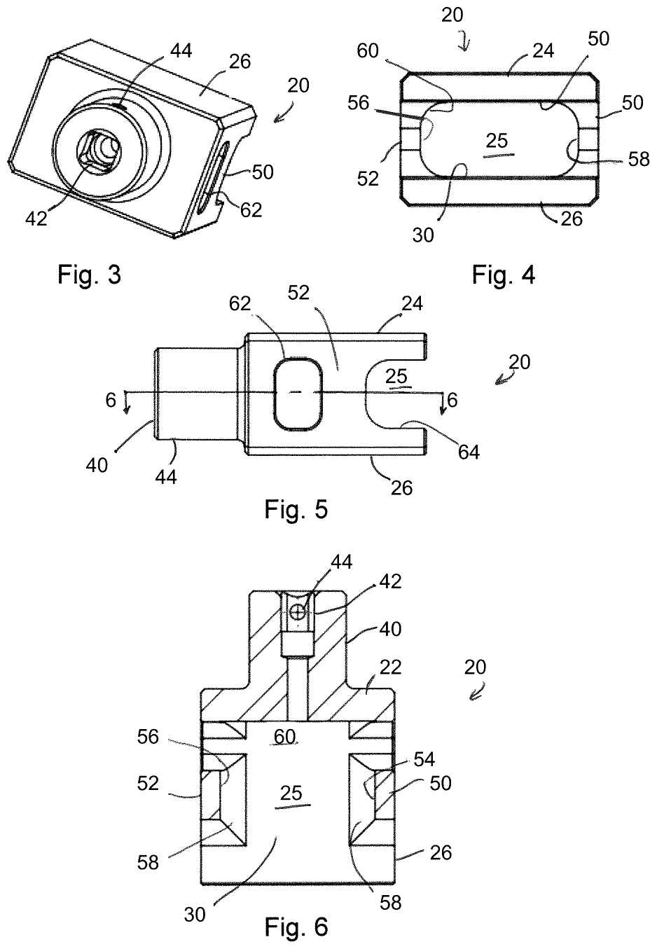

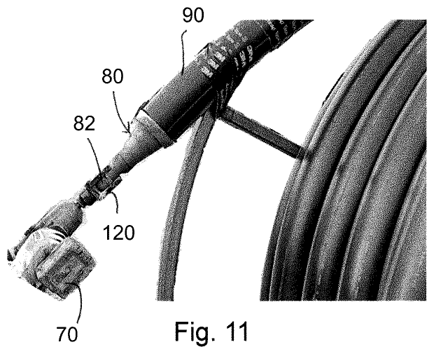

FIGS. 1-6 show a tool 20 (e.g., a tool attachment) according to embodiments of this invention. The tool 20 includes a base 22 with two side extensions 24 and 26 at least partially enclosing a receiving channel 25. The inner surfaces 28 and 30, facing each other, of the two extensions 24 and 26 are shaped and spaced apart to securely receive an eye flange end of a pulling eye within the receiving channel 25 (see FIGS. 10-11). As shown, the inner surfaces 28 and 30 are flat, planar, and parallel to match an eye flange, but other configurations are available depending on need. Spacing and sizing of components can be varied depending on the need and the size and/or shape of the pulling eye. As shown the base 22 and extensions 24 and 26 form a U-shaped socket for an eye flange end of a pulling eye.

The base 22 includes a tool connector 40 on an opposite side from the two extensions 24 and 26. The tool connector 40 includes a drive socket 42, or equivalent, for connection to a rotary power tool. The drive socket 42 is square to attach to a square head drive of an impact wrench anvil, or equivalent. Other suitable tool attachments can be used, depending on the intended rotary tool. As illustrated in FIG. 2, the tool connector 40 includes a detent 44 for receiving a ball of, for example, the tool anvil.

As illustrated, side supports 50 and 52 extend on opposing sides between the two extensions 24 and 26. Side supports 50 and 52 are spaced from the base 22, generally about a midpoint of the side extensions 24 and 26, to provide additional structural support to the extensions 24 and 26. The receiving channel 25 width formed between the two side supports 50 and 52 is likewise sized to fittingly accept the eye flange of the pulling eye. As shown the side supports 50 and 52 include inside surfaces 54 and 56 that are optionally at least partially curved, such as in the area of connection 58 to the corresponding side extensions 24 and 26. The curves match or coordinate with rounded edges of known eye flanges and provide additional strength. The base 22 can include matching curved recession 60 for the eye flange. The side openings 62 and/or side cutouts 64 are also optional, and can be excluded or differently shaped.

The tool of this invention requires a strength to turn the eye flange of larger pulling eyes. The tool is thus desirably made of metal such as steel. The base, side extensions, and/or side supports desirably have a thickness, or a minimum thickness if not planar, of at least about 0.25 inch, and desirably between about 0.25 inch and about 0.5 inch. Again, various configurations, such as a solid side support wall, are available depending on need. All components can be welded together, or otherwise partially or fully formed integral to one another as shown.

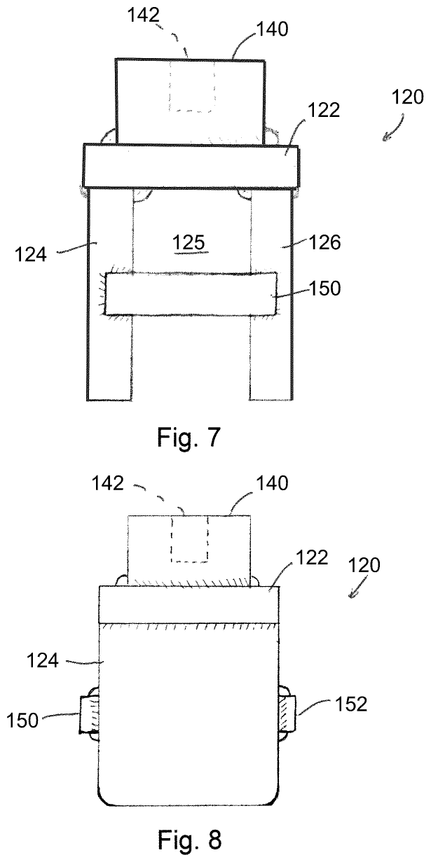

FIGS. 7 and 8 show a tool 120 according to embodiments of this invention. The tool 120 includes a base 122 with two perpendicular extensions 124 and 126 at least partially enclosing a receiving channel 125. The inner surfaces 128 and 130, facing each other, of the two extensions 124 and 126 are shaped and spaced apart to securely set against a flat surface of an eye flange end of a pulling eye within the receiving channel 125. As shown, the inner surfaces 124 and 128 are flat, planar, and parallel, but other configurations are available depending on need. Spacing and sizing of components can be varied depending on the need and the size and/or shape of the pulling eye. As shown the base 122 and extensions 124 and 126 form another U-shaped socket for an eye flange end of a pulling eye.

The base 122 includes a tool connector 140 on an opposite side from the two extensions 124 and 126. The tool connector 140 includes a drive socket 142 for connection to a rotary power tool. The drive socket 142 is square to attach to a square head drive of an impact wrench anvil, or equivalent. Other suitable tool attachments can be used, depending on the intended rotary tool.

As illustrated, side supports 150 and 152 extend on opposing sides between the two extensions 124 and 26. Side supports 150 and 152 provide additional structural support to the extensions 124 and 126. Again, various configurations, such as and X-shaped cross brace or a solid side wall, are available depending on need. In this embodiment, the components are welded together.

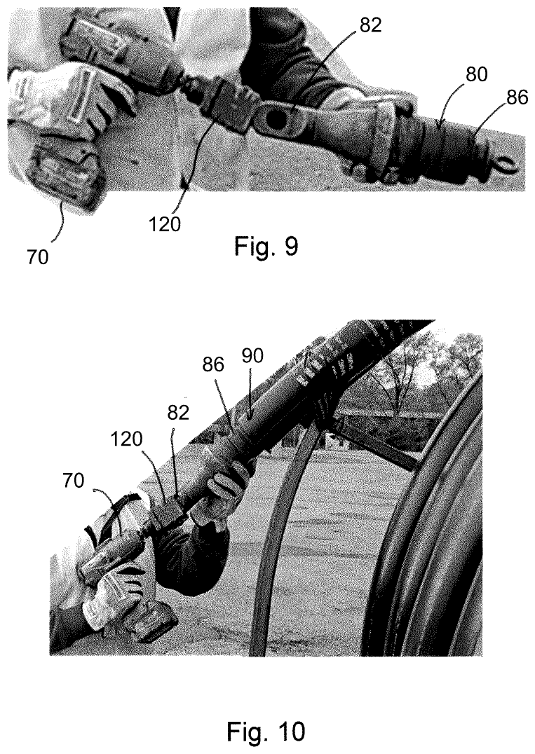

FIGS. 9-11 illustrate a method of use of the invention. FIG. 9 shows a tool 120 according to FIGS. 7 and 8 attached on a rotary power tool 70. An eye flange 82 of a pulling eye 80 is inserted into the receiving channel 125. FIG. 10 shows an opposing end 86 of the pulling eye 80 being inserted into tubing 90 pursuant to normal pulling eye use. FIG. 11 shows the pulling eye 80 being tightened into place within the tubing end using the power tool 70 and tool 120 on the eye flange end 82.

Thus the invention provides a new tool for installing and/or tightening pulling eyes within ends of tubing. The tool includes any suitable receiving socket for an end of a pulling eye, and allows for power tool assisted tightening of the pulling eye within a tubing end.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A tool for using a power tool to install and tighten a pulling eye within a tube, the tool comprising a receiving channel configured to accept an eye flange of the pulling eye.

2. The tool according to claim 1, further comprising a base at a bottom end of the receiving channel, the base including a tool connector on an opposing side from the receiving channel.

3. The tool according to claim 2, further comprising two side extensions extending from the base and forming opposing sides of the receiving channel, wherein the base and the two side extensions form a U-shaped socket as the receiving channel.

4. The tool according to claim 3, wherein the receiving channel has a length that is greater than a width between the two side extensions.

5. The tool according to claim 4, wherein the receiving channel has a length between about 2 inches and about 3 inches.

6. The tool according to claim 5, wherein the receiving channel has a width of about 1 to about 2 inches between the two side extensions.

7. The tool according to claim 1, further comprising:
a base including a tool connector, the base including two opposing sides and two opposing ends; and
two side extensions, each extending from the base along one of the two opposing sides of the base;
wherein the receiving channel is formed between the two side extensions to accept the eye flange of the pulling eye.

8. The tool according to claim 7, further comprising two side supports, each extending between the two side extensions.

9. The tool according to claim 8, wherein an inside surface of each of the two side supports is curved to coordinate with rounded edges of the pulling eye.

10. The tool according to claim 8, wherein the receiving channel has a length of about 2 inches to about 3 inches between the two side supports.

11. The tool according to claim 10, wherein the receiving channel has a width of about 1 inch to about 2 inches between the two side extensions.

12. The tool according to claim 7, wherein the base comprises a tool connector.

13. The tool according to claim 12, where the tool connector comprises a drive socket to receive a drive extension of the tool, and a detent to receive a ball of the drive extension.

14. The tool according to claim 7, wherein the side extensions have a thickness of about 0.25 inch to about 0.5 inch.

15. The tool according to claim 14, wherein the receiving channel has a height or depth of about 2 inches to about 4 inches.

16. A method of installing or tightening a pulling eye, the method comprising:
connecting the tool according to claim 1 to a power tool;
placing the tool over the eye flange of the pulling eye, whereby the eye flange is seated within the receiving channel; and
rotating the tool with the power tool to rotate the pulling eye.

17. The method of claim 16, wherein the pulling eye has threaded components which are tightened within a tube or conduit.

18. The method of claim 16, wherein the power tool is a power drill, an impact drill, or an impact driver.
